(19) United States
(12) Patent Application Publication
(10) Pub. No.: US 2011/0233272 A1
(43) Pub. Date: Sep. 29, 2011

(54) ELECTRONIC BOOK WITH CLAMPING DEVICE FOR SUPERPOSITION OF MULTI-BOOKS

(76) Inventor: Yim wai Yau, Hong Kong (CN)

(21) Appl. No.: 13/119,178

(22) PCT Filed: Sep. 16, 2009
(86) PCT No.: PCT/CN2009/073956

§ 371 Date: Jun. 3, 2011

(30) Foreign Application Priority Data
Sep. 16, 2008 (CN) 200820147161.3
Sep. 23, 2008 (CN) 200820147561.4
Sep. 28, 2008 (CN) 200820212084.5

(51) Int. Cl. G06F 17/00

(52) U.S. Cl. 235/375

(57) ABSTRACT

The present invention contains an electronic book, a processor board or an IC card, and an electronic capturing device. The electronic book contains a paper book wrapped within a cover and a ridge member is provided between the cover and the paper book. The ridge member is in contact with the ridge of the paper book through a curved front contact surface. The contact surface and the ridge are not fixedly attached. The paper book contains a number of pages, and each page is printed with invisible codes. The invisible codes could be detected by the electronic capturing device and processed by the processor board or IC card. The related content then could be read by externally connected electronic reading device or card reader.

### TECHNICAL FIELD OF THE INVENTION

The present invention is generally related to printed books and electronic devices, and more particularly to a teaching where multiple such integrations could be stacked together.

### DESCRIPTION OF THE PRIOR ART

Various printed documents and material are an essential part of our daily life. Yet, the ways information is presented and delivered by the printed material are rather limited.

Following the advancement of the digital and communication technologies, various media for information delivery are invented, such as the electronic books, learning machines, PDAs.

In the education arena, therefore there is a paperless idea which is intended to reduce children's burden by digitizing and storing printed textbooks a hand-held electronic reading device or a tablet computer. However, this idea has not yet been successfully implemented.

Even though various manufacturers have been continuously pushing new solutions and products into the market, the result is still far from satisfactory It turns out that the conventional printed material has advantages such as convenience, simplicity, etc. that cannot be easily replaced by electronic devices. It seems that the printed material cannot be entirely replaced and that conventional publication industry could not treat the digital revolution lightly. It is inevitable that printed material and electronic reading will co-exist.

As such, a new reading style combining printed material and electronic device or media has occurred. For example, there are books accompanied with optical disks, storage cards. There are also books used together with electronic reading devices.

The idea is to store some elements of the printed material in the disks or cards. It is also possible to add interaction capability such as inserting comment, marking, connecting keywords to their explanations, associating with audio and video clips. The main problem is that the disks and cards are required additional device and separate process to gain the additional benefit.

However, integrating printed books and electronic technology is an inevitable trend and researchers have been working diligently to seek breakthroughs.

For example, codes are embedded in the printed book and accessed by optical recognition technique. However, strict printing condition has to be followed and content editing requires professionals.

There are also proposals of integrating RFID with printed books. Theoretically it should be feasible, but it is not a practical solution.

RFID is a non-contact automatic reading technology where an object is identified by radio signal and relevant information is accessed. The object should have an attached tag of unique coding accessible to a reading device. For a book, there are too numerous elements and it is not practical to associate a tag for each of them.

Actually, RFID is not appropriate for reading and it is more appropriate for tracking inventory and supply management.

OCR (Optical Character Recognition) is to convert printed text into digital text by scanning and image processing. Quite a number of devices for the blind are developed using OCR related technologies. The recognition process involves image input, pre-processing, feature extraction, comparison and recognition. Human correction is sometimes inevitable (which is impossible for the blind). Finally, the recognition result is produced.

Touch reader having electronic coordinate sensing is another approach. A printed book is placed on a tablet with grid antenna circuit board and a signal generator touches a data page of the book. The X-Y coordinates of the touched point is determined and electronic data associated with the coordinates is obtained. The working mechanism is as follows. A radio circuit transmits a radio signal of a fixed frequency. The grid antenna circuit detects the radio signal, and filters, amplifies, and transforms the signal before sending it an A/D terminal of processor board. The processor board identifies the X-Y coordinates, accesses a database accordingly, and presents the result on a reading device.

Compared with the foregoing technologies, the touch reader having electronic coordinate sensing seems to be more promising. First, electronic coordinate sensing has superior reliability and resolution and, secondly, its production is simpler and less expensive.

Additionally, electronic coordinate sensing is theoretically appropriate for the blind, especially for synchronous pronunciation.

Electronic coordinate sensing also has its disadvantages. For example, the electronic coordinate circuit board has to be precisely aligned with the printed content. However, this would be a challenge to the blind.

In order to identify different data pages, the electronic coordinate circuit requires the capability to allow users to select pages. This would be even more challenging to the blind.

On the other hand, the radio circuit cannot radiate too strong or too weak a radio signal. If the radio signal is too strong, there is a high probability of misjudgement of the touched point. If the radio signal is too weak, it cannot penetrated a thick book and cannot be picked up by the electronic coordinate circuit. However, for the books for the blind, they are usually much thicker than the ordinary books.

To successfully integrating printed books and digital technologies, and especially to help the blind in effectively learning and working, the present inventor has already proposed a number of solutions integrating printed books with PDAs such as the Taiwan Patent Application Serial Nos. 2004100792168, 2005100653136, 2005100883778. These teachings, despite their usefulness, still have limited application and some restriction.

### SUMMARY OF THE INVENTION

A major objective of the present invention is to effectively integrate printed books and electronic reading devices.

To achieve the objective, the present invention contains an electronic book, a processor board or an IC card, and an electronic capturing device. The electronic book contains a paper book wrapped within a cover and a ridge member is provided between the cover and the paper book. The paper book has a front cover, a back cover, and a ridge. The front and back covers are both attached to an inner surface of the cover of the electronic book. The ridge member is in contact with the ridge of the paper book through a curved front contact surface. The contact surface and the ridge are not fixedly attached. The paper book contains a number of pages, and each page is printed with invisible codes. The invisible codes could be detected by the electronic capturing device and processed by the processor board or IC card. The related content then could be read by externally connected electronic reading device or card reader.

The ridge member has a rectangular shape and contains the processor board or IC card, and an USB socket. The contact surface of the ridge member and the ridge of the paper book have compatible shapes.

The electronic book contains grid antenna circuit boards, and a radio circuit emitting a fixed-frequency radio signal. Each of the grid antenna circuit boards contains a number of parallel metallic wires along an X axis interleaved with a number of parallel metallic wires along a Y-axis into a grid. The grid antenna circuit boards are capable of detecting the fixed-frequency radio signal from the radio circuit. The grid antenna circuit boards are electrically connected to an A/D portion of the processor board or the IC card.

Conductive elements are provided on the ridge member's lateral sides, respectively. The conductive elements are electrically connected to the processor board or IC card.

Also on the ridge member's lateral sides, there are magnetic elements of opposite polarities, respectively.

The grid antenna circuit boards have their surfaces facing the cover coated with metallic grease layers or metallic films, respectively.

Each page is printed with invisible codes, each containing a number of miniature graphical elements printed by fluorescent ink. The fluorescent ink is detectable under the infrared light emitted by an infrared transmitter of the electronic capturing device. Different data pages could have invisible codes of different specifications.

The electronic capturing device contains a photoelectric device and a radio circuit. The photoelectric device contains an infrared transmitter, a camera, a photoelectric conversion circuit. The camera picks up a reflected image of the invisible codes and the photoelectric conversion circuit delivers the recognized electronic data to the processor board or IC card. The radio circuit emits a fixed-frequency radio signal which is detectable by the grid antenna circuit boards.

At least a battery could be housed inside the ridge member. The processor board or IC card could be equipped with transmission and reception circuit so that their data could be exchanged with external electronic reading device or related circuit in a wireless manner.

An adjustable clamping device contains a clamping member and covers. The clamping member contains at least two clamping pieces, two fixation elements, and a number of fastening elements. The opposing clamping pieces, connected by the fixation elements from the top and bottom, jointly form a rectangular space. The distance between the clamping pieces could be adjusted by the fixation elements so that the rectangular space could accommodate more than one electronic book. The clamping pieces have conductive elements, corresponding to those on the ridge members of the electronic books and thereby connected to the processor boards or IC cards. As such, data from the electronic books could be transmitted to an externally connected electronic reading device or card reader of the clamping device. The clamping pieces also have magnetic elements of opposite polarities, corresponding to those on the ridge members of the electronic books.

The gist of the present invention lies in the novel integration of printed books and electronic reading devices. The printed books could still be read in an ordinary manner while, together with the electronic reading device, a richer reading experience could be achieved.

The present invention has the following features.

First, by having an appropriate thickness for the electronic book, the precision of the detecting the radio signal could be maintained with a radio signal of moderate strength.

Secondly, the stacked electronic books are cascaded in a series connection so that the present invention is not confined by the thickness of electronic book.

Thirdly, through the electronic capturing device, an addressing (including page number, coordinates, and the related content) mechanism is achieved as follows.

The page number could be embedded in the invisible codes on that page. The X-Y coordinates of the location touched by the electronic capturing device could be determined by the grid antenna circuit boards. Then, the processor board or IC card could provide biblical information to the book and related data such as text, picture, audio, and video.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1A is a schematic diagram showing a paper book wrapped by a cover and a ridge member into an electronic book according to an embodiment of the present invention.

FIG. 1B is a schematic diagram showing the ridge member of FIG. 1.

FIG. 1C is a schematic diagram showing grid antenna circuit boards according to an embodiment of the present invention.

FIG. 1D is a schematic diagram showing the grid antenna circuit boards of FIG. 1C used together with pages of a book.

FIG. 2A is a schematic sectional diagram showing the ridge member of FIG. 1B.

FIG. 2B is a schematic cross-sectional diagram showing the ridge member of FIG. 1B along the A viewing direction shown in FIG. 2A.

FIG. 2C is a schematic top-view diagram showing the ridge member of FIG. 1B.

FIGS. 2D and 2E are schematic diagrams showing the electrical connection between neighboring ridge members of FIG 1B.

FIG. 2F is a schematic diagram showing batteries are housed inside the ridge member of FIG. 1B.

FIG. 2G is a schematic diagram showing a ridge member of FIG. 1B is equipped with an IC card.

FIG. 3A is a schematic diagram showing an electronic capturing device of the present invention in a wired configuration.

FIG. 3B is a schematic diagram showing an electronic capturing device of the present invention in a wireless configuration.

FIG. 3C is a schematic circuit reference diagram of a radio circuit of the electronic capturing device of FIGS. 3A and 3B.

FIG. 4A is a schematic diagram showing the scenario of opening an electronic book of the present invention.

FIG. 4B is a schematic diagram showing the stacking of multiple electronic books of the present invention.

FIG. 4C is a schematic diagram showing the penetration of radio signal through the electronic book of the present invention.

FIG. 4D is a schematic diagram showing the radio signal of FIG. 4C is shielded by metallic films of the present invention.

FIGS. 5A and 5B are schematic diagrams showing the present invention is integrated with a PDA.

FIG. 5C is a schematic diagram showing a wireless connection to an external electronic reading device.

FIG. 5D is a schematic diagram showing a wired connection to an external electronic reading device.

FIG. 5E is a schematic diagram showing a learning machine with speaker is integrated with the present invention.

FIG. 6 is a schematic diagram showing multiple electronic books are integrated with an adjustable clamping device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

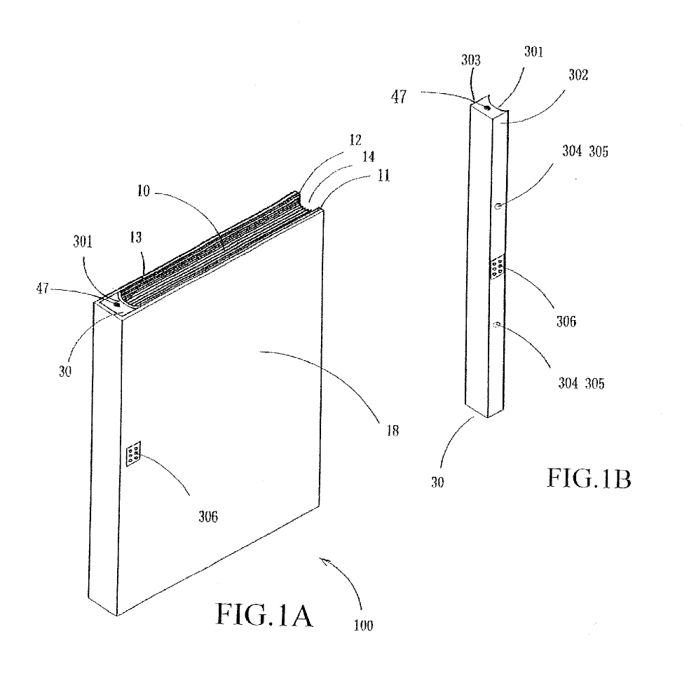

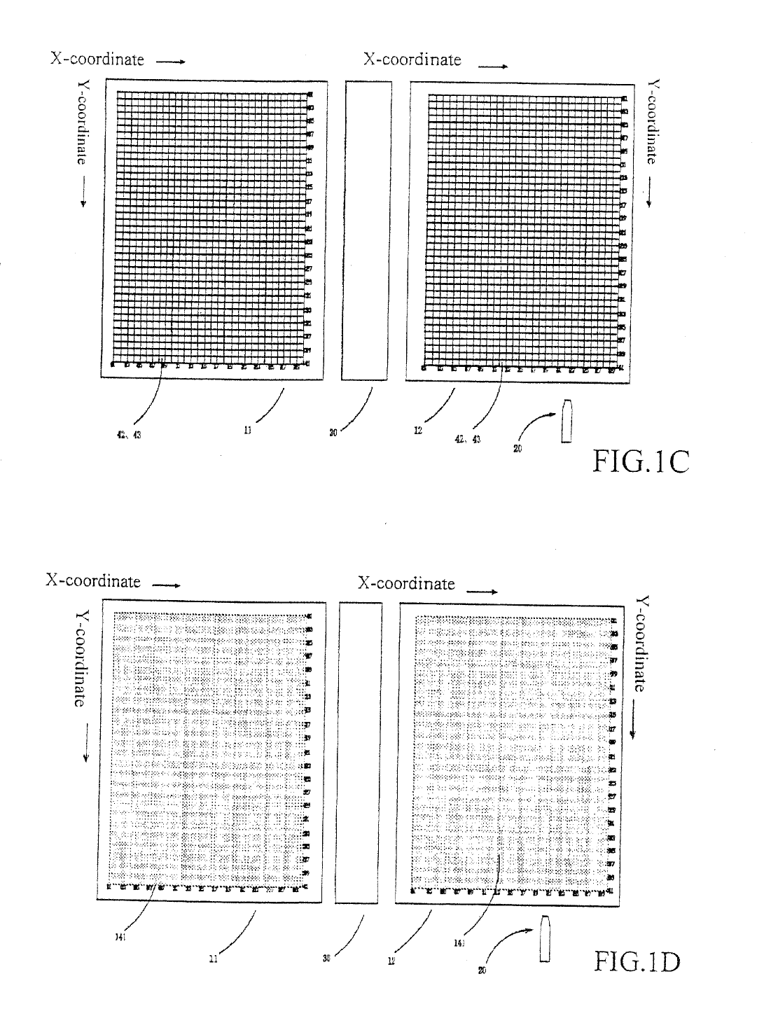

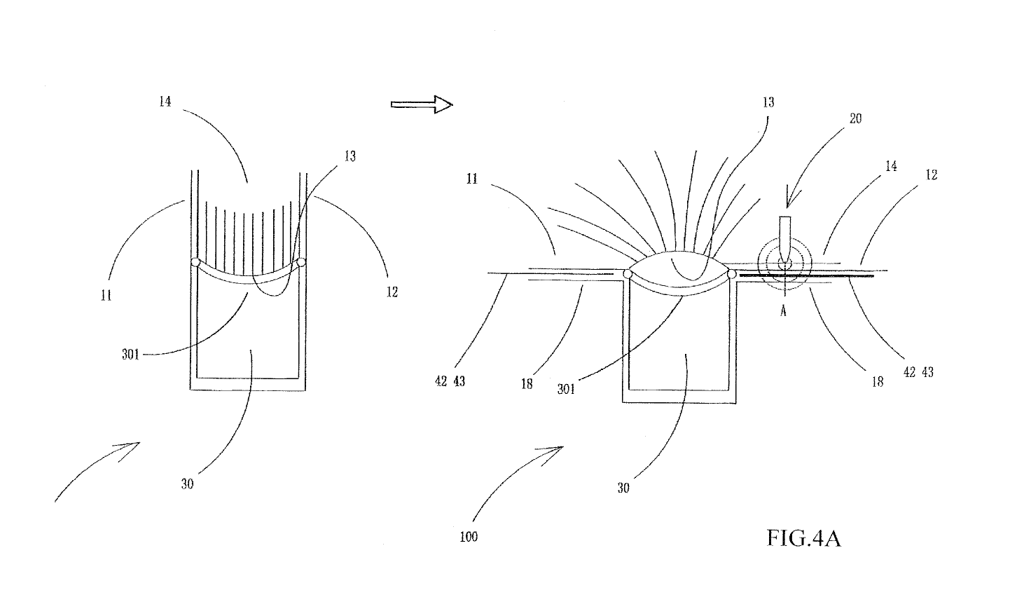

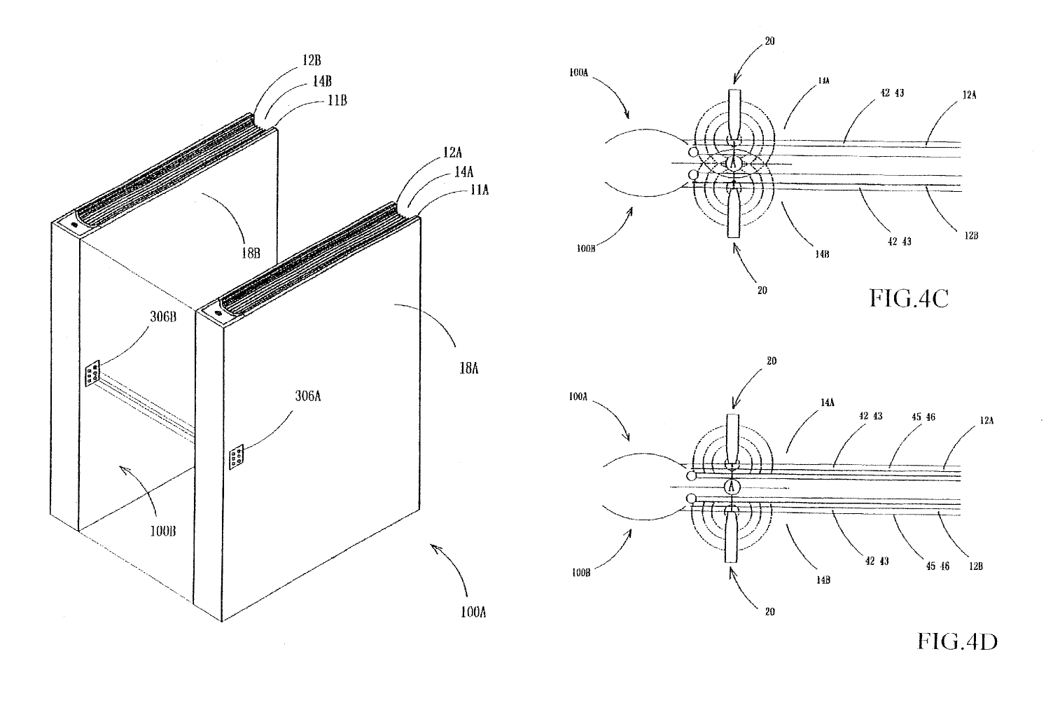

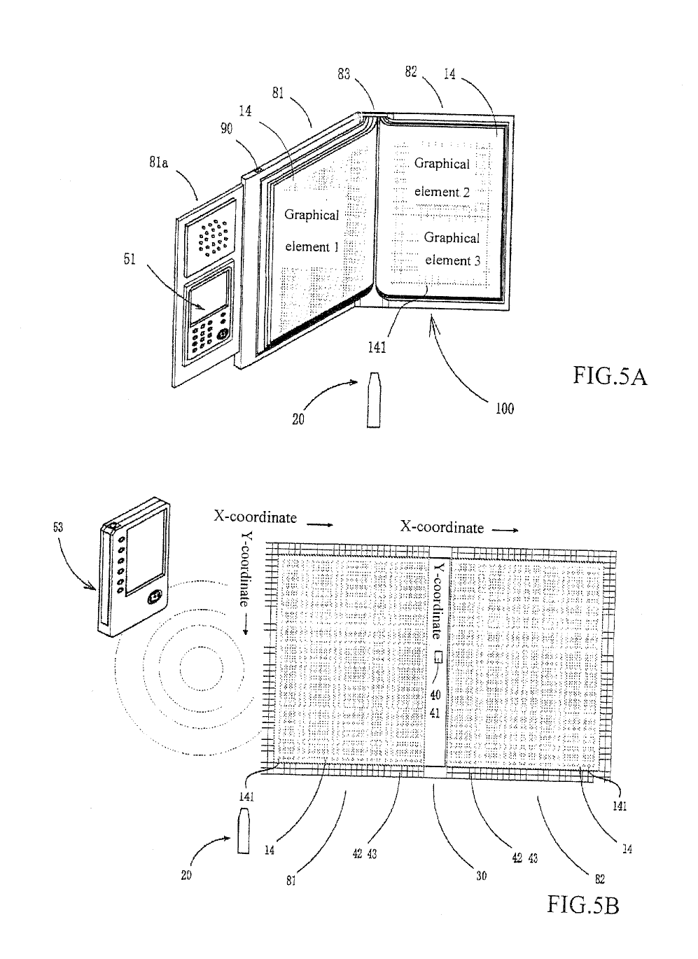

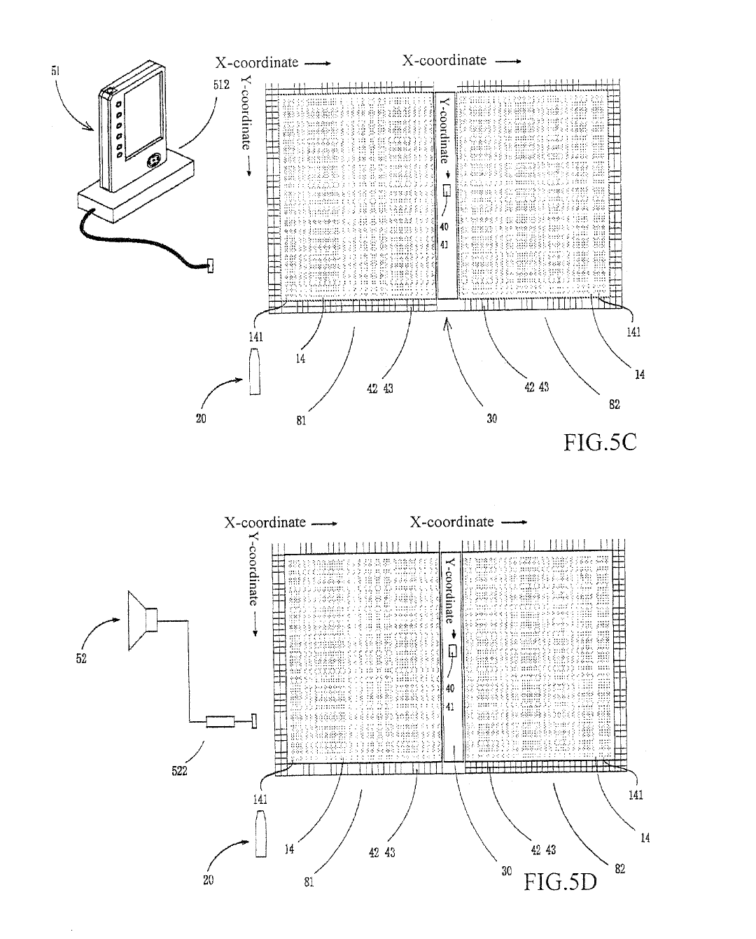

As shown in FIG. 5, the present invention contains an electronic book 100 having a paper book 10 wrapped within a cover 18, a processor board 40 with built-in storage or an IC card 41, and an electronic capturing device 20. Between the cover 18 and the paper book 10, a ridge member 30 is provided. The ridge member 30 is attached to the cover 18 and is in contact with a ridge 13 of the paper book 10 through a curved front contact surface 301. The paper book 10 has a front cover 11 and a back cover 12, both attached to an inner surface of the cover 18. As shown in FIGS. 1 and 4A, the ridge member 30's lateral sides and a back side are adhered to an inner surface of the front and back cover 11 and 12, and the cover 18. The contact surface 301 and the ridge 13 are not fixedly attached. When the paper book 10 is fully opened, the ridge 13 would be at a distance from the contact surface 301. The cover 18 is made of a soft, flexible, highly bendable material, or it could an assembly with plastic piece.

Please note that the front and back covers 11 and 12 use the two lateral edges of the contact surface 301 as pivots for page flipping. This is a major feature of the present invention. As such, the pages of the paper book 10 could be flipped and placed flatly on the front and back covers 11 and 12, effectively resolving the problem of misalignment between a paper book and a grid antenna circuit board of an electronic reading device in obtaining the X-Y coordinates of a point on a page of the paper book.

The paper book 10 contains a number of pages 14 bound together. Invisible codes 141 are printed on the pages 14 and the electronic capturing device 20 is capable of recognizing the invisible codes 141 and delivering the recognition result to the processor board 40 or the IC card 41 so that related content could be read by an externally connected electronic reading device or a card reader.

The ridge member 30 has a rectangular shape and contains the processor board 40 or IC card 41, and an USB socket 47. The contact surface 301 of the ridge member 30 and the ridge 13 of the paper book 10 have compatible shapes.

The ridge member 30 is individually shown in FIG. 1B. It is for housing electronic components and for establishing connectivity. It could be formed into the elongated solid object by plastic molding.

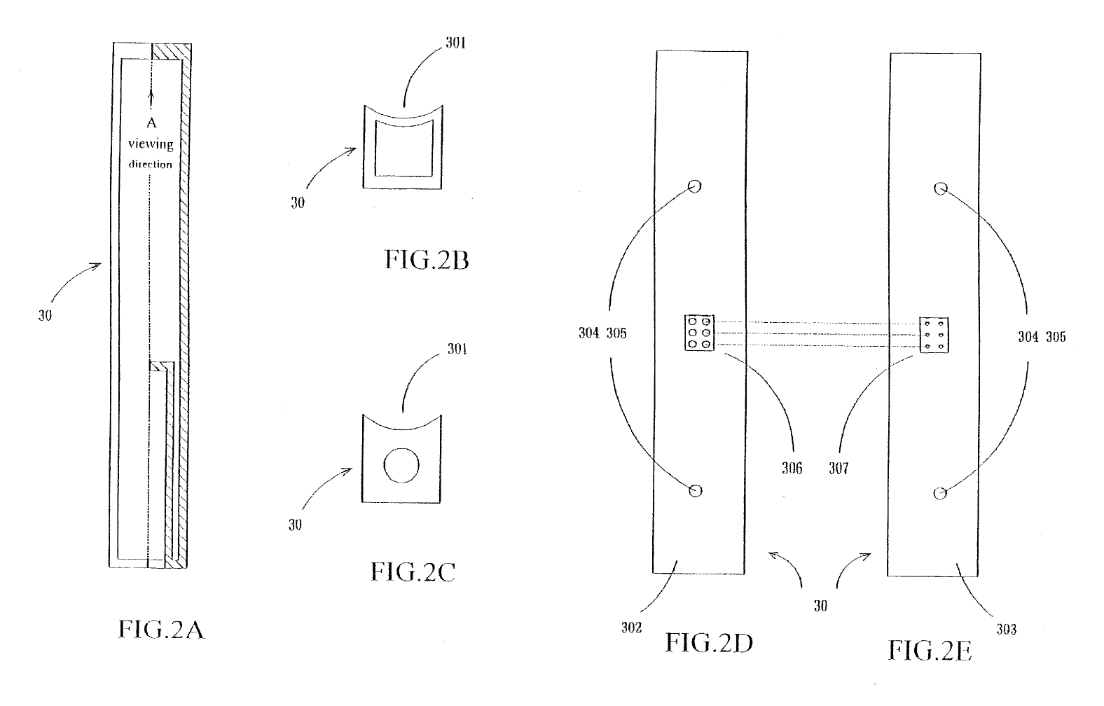

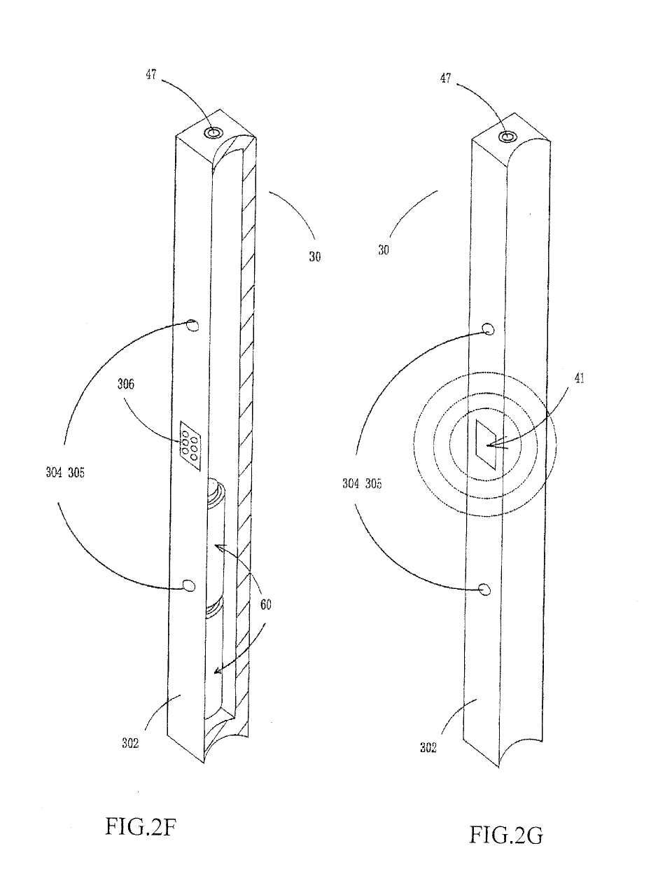

As shown in FIG. 2A, the contact surface 301 of the ridge member 30 and the ridge 13 of the paper book 10 are both curved and have compatible shapes. The paper book 10 could be an ordinary volume of pages with ridge and covers such as a book, a photo album, etc. The ridge 13 could be made of a soft material such as fabrics.

As shown in FIGS. 1C and 1D, the electronic book 100 contains grid antenna circuit boards 42 and 43, a radio circuit 21 emitting a fixed-frequency radio signal. Each of the grid antenna circuit boards 42 and 43 contains a number of parallel metallic wires along an X axis interleaved with a number of parallel metallic wires along a Y-axis into a grid. The grid antenna circuit boards 42 and 43 could be made of a flexible conducting film, and are capable of detecting the fixed-frequency radio signal from the radio circuit 21. The grid antenna circuit boards 42 and 43 are placed between the front and back covers 11 and 12, and the cover 18, respectively, and are electrically connected to an A/D portion of the processor board 40 or the IC card 41.

Conventionally, the total thickness of the pages 14 of the paper book 10 should be not too great so that the fixed-frequency radio signal from the radio circuit 21 could penetrate the pages 14 and be picked up by the grid antenna circuit boards 42 and 43.

In order to obviate the foregoing book thickness limitation, as shown in FIG. 4A, conductive elements 306 and 307 are provided on the ridge member 30's lateral sides 302 and 303, respectively. The conductive elements 306 and 307 are electrically connected to the processor board 40 or IC card 41.

Also on the ridge member 30's lateral sides 302 and 303, there are magnetic elements 304 and 305 of opposite polarities, respectively. When more than one electronic book 100 are placed side by side together, the electronic books 100 could be bound together by the magnetic attraction between the magnetic elements 304 and 305 of neighbouring electronic books 100.

Similarly, when more than one electronic book 100 are placed side by side together, the conductive elements 306 and 307 of neighbouring electronic books 100 are electrically connected in series together into a circuit via the ridge members 30 of the electronic books 100. As such, data from the electronic books 100 could be transmitted through the circuit.

The stacked or bundled electronic books 100 could all be under the influence of the radio signal from the radio circuit 21. An example of the coverage of the radio signal is shown in FIG. 4C.

The grid antenna circuit boards 42 and 43 have their surfaces facing the cover 18 coated with metallic grease layers or metallic films 45 and 46, respectively. As shown in FIG. 4D. The penetration of the radio signal is shielded by the metallic grease layers or metallic films 45 and 46.

Each of the pages 14 is printed with invisible codes 141, each containing a number of miniature graphical elements forming a single geometric pattern,

Arabic numbers, Roman numerals, English alphabet, or character combinations. The miniature graphical elements are printed by fluorescent ink and are difficult to detect visually. They are however detectable under the infrared light. Different pages 14 could have invisible codes 141 of different specifications. As the miniature graphical elements are barely detectable by human vision, the printed content by ink not absorbing infrared on the pages 14 is not affected. The printed content therefore could be overlapped or not overlapped with the invisible codes 141.

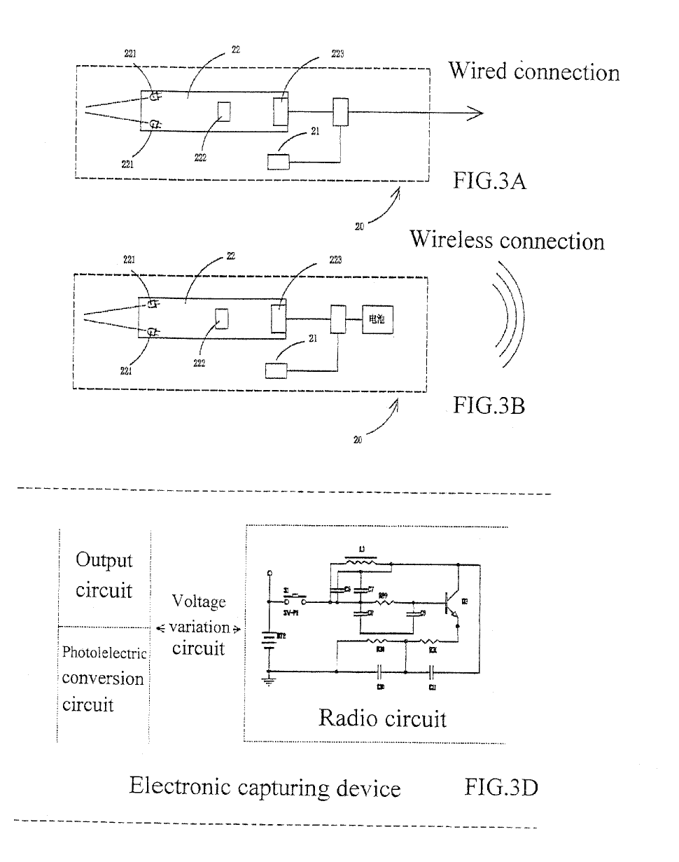

As shown in FIG. 3, the electronic capturing device 20 mainly contains a photoelectric device 22 and the radio circuit 21. The photoelectric device 22 contains an infrared transmitter 221, a camera 222, and a photoelectric conversion circuit 223. The camera 222 picks up a reflected image of the invisible codes 141 and the photoelectric conversion circuit 223 delivers the recognized electronic data to the processor board 40 or IC card 41. As such, whether a page 14 has ink-printed content or no ink-printed content (but with Braille characters), the electronic capturing device 20 is capable of obtaining the invisible codes 141 on the pages 14.

Even though multiple pages 14 are stacked, the electronic capturing device 20 will not detect the invisible codes 141 on the lower pages 14, as long as the infrared transmitter 221 is tuned appropriately.

As shown in FIG. 4A, the radio circuit 21 transmits a fixed-frequency signal for the grid antenna circuit boards 42 and 43 to detect. When location A on a page 14 is touched by the electronic capturing device 20, the grid antenna circuit boards 42 and 43 would detect the fixed-frequency signal, process it, and deliver it to the processor board 40 or IC card 41. The X-Y coordinates to the location A then can be determined.

Based on the location data and other data obtained by the electronic capturing device 20 such as the invisible codes 141, the processor board 40 or IC card 41 produces related electronic data and the associated content (such as text, images, audio and video, etc.) could be accessed by a connected electronic reading device or card reader.

The built-in storage of the processor board 40 or the IC card 41 could use flash memory and the electronic book 100 could be powered by externally connected electronic reading device 51 with battery base 512 or by the internal power 522 of a learning machine 52.

As shown in FIG. 2G, the IC card 41 within the ridge member 30 could be accessed in a non-contact, radio sensing manner to deliver its stored data or to receive the data from a card reader.

At least a battery 60 could be housed inside the ridge member 30. The processor board 40 or IC card 41 could be equipped with transmission and reception circuit so that their data could be exchanged with external electronic reading device or related circuit in a wireless manner.

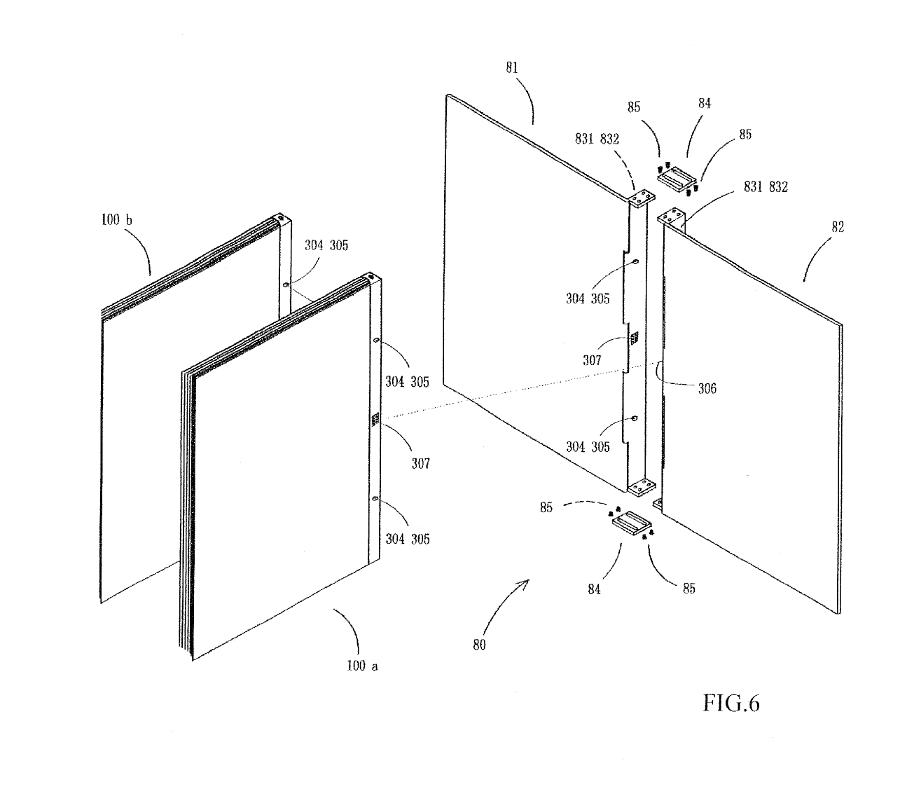

As shown in FIG. 6, the present invention could be integrated with the present inventor's another invention which is about an adjustable clamping device 80. The adjustable clamping device 80 contains clamping member 83 and covers 81 and 82. The clamping member 83 contains at least two clamping pieces 831 and 832, two fixation elements 84, and a number of fastening elements 85. The opposing clamping pieces 831 and 832, connected by the fixation elements 84 from the top and bottom, jointly form a rectangular space. The distance between the clamping pieces 831 and 832 could be adjusted by the fixation elements 84 so that the rectangular space could accommodate more than one electronic book 100. The clamping pieces 831 and 832 have conductive elements 306 and 307, corresponding to those on the ridge members 30 of the electronic books 100 and thereby connected to the processor boards 40 or IC cards 41. As such, data from the electronic books 100 could be transmitted to an externally connected electronic reading device or card reader of the clamping device 80. The clamping pieces 831 and 832 also have magnetic elements 304 and 305 of opposite polarities, corresponding to those on the ridge members 30 of the electronic books 100.

In an alternative embodiment, an electronic book 100 equipped with an internal battery functions as a main volume and the main volume is stacked with other electronic books 100 without battery as auxiliary volumes. A user could make the combination according to his or her needs, and browse the data from an externally connected electronic reading device or a card reader.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An electronic book, comprising:
a paper book having a front cover, a back cover, a ridge, and a plurality of pages, each page printed with invisible codes;
a cover wrapping said paper book, said front and back cover of said paper book being attached to an inner surface of said cover,;
a ridge member attached to said cover and positioned between said cover and said paper book, said ridge member having a contract surface detachably interfacing with said ridge of said paper book;
a processor board with built-in storage or an IC card; and
an electronic capturing device having a radio circuit emitting a fixed-frequency radio signal and capable of recognizing said invisible codes and delivering the recognition result to said processor board or IC card so that related contact is read by an externally connected electronic reading device or card reader.

2. The electronic book according to claim 1, wherein said ridge member has a rectangular shape and contains said processor board or IC card, and an USB socket; said contact surface of said ridge member and said ridge of said paper book have compatible shapes.

3. The electronic book according to claim 1, further comprising at least a grid antenna circuit board, said grid antenna circuit board comprising a plurality of parallel metallic wires along an X axis interleaved perpendicularly with a plurality of parallel metallic wires along a Y-axis; said grid antenna circuit board capable of detecting said fixed-frequency radio signal from said radio circuit, and said grid antenna circuit board electrically connected to an AID portion of said processor board or said IC card.

4. The electronic book according to claim 1, wherein a plurality of conductive elements are provided on said ridge member's lateral sides, respectively; and said conductive elements are electrically connected to said processor board or IC card.

5. The electronic book according to claim 1, wherein a plurality of magnetic elements are provided on said ridge member's lateral sides, respectively; and said magnetic elements on separate sides are of different polarities.

6. The electronic book according to claim 3, wherein said grid antenna circuit board's surfaces facing said cover is coated with a metallic grease layer or a metallic film.

7. The electronic book according to claim 1, wherein said invisible code contains a plurality of miniature graphical elements using fluorescent ink detectable under an infrared light emitted by an infrared transmitter of said electronic capturing device; and different pages have invisible codes of different specifications.

8. The electronic book according to claim 1, wherein said electronic capturing device comprises a photoelectric device and said radio circuit; said photoelectric device comprises an infrared transmitter, a camera, and a photoelectric conversion circuit; said camera picks up a reflected image of said invisible codes; and said photoelectric conversion circuit delivers the recognized electronic data to said processor board or IC card.

9. The electronic book according to claim 2, wherein at least a battery is housed inside said ridge member; and said processor board or IC card is equipped with a transmission and reception circuit so that their data could be exchanged with an external electronic reading device or related circuit in a wireless manner.

10. The electronic book according to claim 1, further comprising an adjustable clamping device wherein said clamping device contains a clamping member and covers; said clamping member contains at least two opposing clamping pieces, two fixation elements, and a plurality of fastening elements; said clamping pieces, connected by said fixation elements from the top and bottom, jointly form a rectangular space; the distance between said clamping pieces is adjustable by said fixation elements so that the rectangular space is able to accommodate more than one electronic book; said clamping pieces have conductive elements, corresponding to those on said ridge members of said electronic books and thereby connected to said processor boards or IC cards; and said clamping pieces have magnetic elements of opposite polarities, corresponding to those on said ridge members of said electronic books.

11. The electronic book according to claim 3, wherein said electronic capturing device comprises a photoelectric device and said radio circuit; said photoelectric device comprises an infrared transmitter, a camera, and a photoelectric conversion circuit; said camera picks up a reflected image of said invisible codes; and said photoelectric conversion circuit delivers the recognized electronic data to said processor board or IC card.
